(19) United States
(12) Patent Application Publication
(10) Pub. No.: US 2011/0299623 A1
(43) Pub. Date: Dec. 8, 2011

(54) DEVICE AND METHOD FOR PROCESSING BEAMFORMING FREQUENCY

(75) Inventors: Yanwen Wang, Shenzhen (CN); Xianming Lu, Shenzhen (CN); Li Zhang, Shenzhen (CN)

(73) Assignee: ZTE CORPORATION, Shenzhen, Guangdong (CN)

(21) Appl. No.: 13/201,581

(22) PCT Filed: Dec. 17, 2009
(86) PCT No.: PCT/CN2009/075681

§ 371 Date: Aug. 15, 2011

(30) Foreign Application Priority Data
Feb. 16, 2009 (CN) 200910078096.2

(51) Int. Cl. H04L 27/00

(52) U.S. Cl. 375/295

(57) ABSTRACT

The present invention discloses a device and method for processing beamforming frequency. The device for processing beamforming frequency includes a setting unit, an encoding unit, a mapping unit and a beam grouping generating unit, wherein the setting unit is used for setting an encoding matrix; the encoding unit is used for encoding input initial data according to the encoding matrix; the mapping unit is used for obtaining encoded column data from the encoding unit and mapping the encoded column data to antenna groups corresponding to subspaces; and the beam grouping generating unit is used for generating beam groups corresponding to the antenna groups. The method for processing beamforming frequency includes: setting an encoding matrix; encoding initial data according to the encoding matrix; mapping encoded column data to antenna groups corresponding to subspaces; and generating beam groups corresponding to the antenna groups.

### TECHNICAL FIELD

The present invention relates to a beamforming frequency processing technology in mobile communication system, and in particular to a device and method for processing multi-antenna beamforming frequency.

### BACKGROUND

In a 3 Gpp Long-Term Evolution (LTE) system, the downlink defines a diversity mode as Space Frequency Block Codes (SFBC) when there are two transmission antennae, and the encoding matrix thereof is

$$[ \begin{matrix}{x}_{1} & - {x}_{2}^{*} \\ {x}_{2} & {x}_{1}^{*}\end{matrix} ] .$$

All the lines of the encoding matrix correspond to different frequencies, and all the columns thereof correspond to different antennae. The line data of the encoding matrix represents data sent on corresponding frequency, and the column data thereof represents data mapped to corresponding antenna. Specifically, from top to down, the first line represents data sent on frequency 1, and the second line represents data sent on frequency 2; from left to right, the first column represents data mapped to antenna 1, and the second column represents data mapped to antenna 2. Moreover, x₁ and x₂ are symbols before space frequency block coding, x* represents the conjugation of x, for example, x*₁ represents the conjugation of x₁.

In the LTE system, the downlink also defines a diversity mode as SFBC+Frequency Switch Time Division (SFBC+FSTD) when there are four transmission antennae, and the encoding matrix thereof is

$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] .$$

All the lines of the encoding matrix correspond to different frequencies, and all the columns thereof correspond to different antennae. The line data of the encoding matrix represents data sent on corresponding frequency, and the column data thereof represents data mapped frequency, and the column data thereof represents data mapped to corresponding antenna. Specifically, from top to down, the first line represents data sent on frequency 1, the second line represents data sent on frequency 2, the third line represents data sent on frequency 3, and the fourth line represents data sent on frequency 4; from left to right, the first column represents data mapped to antenna 1, the second column represents data mapped to antenna 2, the third column represents data mapped to antenna 3, and the fourth column represents data mapped to antenna 4. Moreover, x₁, x₂, x₃ and x₄ are symbols before space frequency block coding, x* represents the conjugation of x, for example, x*₁ represents the conjugation of x₁.

In a 3 Gpp Long-Term Evolution Advanced (LTE-A) system, in order to enhance downlink data transmission rate and frequency spectrum utilization rate and obtain more diversity gain, the downlink can utilize at most eight antennae for transmission. However, in the case of eight antennae, there has not developed a corresponding solution by far to realize the multi-antenna diversity when there are eight antennae.

### SUMMARY

In view of the problem above, the purpose of the present invention is to provide a device and method for processing beamforming frequency, capable of realizing efficient and directional coverage multi-antenna diversity in the case of eight or more antennae, thereby improving diversity gain.

In order to achieve the purpose above, the technical solution of the present invention is realized by:

The present invention provides a device for processing beamforming frequency, which comprises: a setting unit, an encoding unit, a mapping unit and a grouping beam generating unit, wherein

the setting unit is used for setting an encoding matrix and sending the encoding matrix to the encoding unit;

the encoding unit is used for encoding input initial data according to the encoding matrix;

the mapping unit is used for obtaining encoded column data from the encoding unit and mapping the encoded column data to antenna groups corresponding to subspaces; and

the grouping beam generating unit is used for generating grouping beams corresponding to the antenna groups.

Wherein, the grouping beam generating unit may be further used for calculating weights according to channel information fed back by a terminal side and generating directional grouping beams corresponding to the antenna groups.

The present invention further provides a method for processing beamforming frequency, which comprises:

setting an encoding matrix, wherein frequencies corresponding to lines of the encoding matrix are neighboring sub-carriers, and spaces corresponding to columns thereof are neighboring subspaces which are obtained by dividing an entire space;

encoding initial data according to the encoding matrix;

obtaining encoded column data and mapping the encoded column data to antenna groups corresponding to the subspaces; and

performing beam generation and generating grouping beams corresponding to the antenna groups by a grouping beam generating unit.

Wherein, the encoded column data may be further mapped to the antenna groups corresponding to the subspaces via a port;

when mapping, the encoded column data may be mapped via a port to at least one antenna group in which at least one antenna is included.

Wherein, the step of generating the grouping beams corresponding to the antenna groups may further comprise: calculating by an antenna groups a weight according to channel information fed back by a terminal side and generating a directional grouping beam corresponding to the antenna group.

Wherein, a main lobe of the directional grouping beam may direct a Direction of Arrival (DOA) at which energy of transmission signals of the antennae in the antenna group is the greatest.

Wherein, the encoding matrix may be

$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$

in which x₁, x₂, x₃ and x₄ represent the initial data; frequencies corresponding to different lines of the encoding matrix are different neighboring sub-carriers, specifically sub-carrier 1, sub-carrier 2, sub-carrier 3 and sub-carrier 4 in turn from top to down; spaces corresponding to different columns are different neighboring subspaces obtained by dividing an entire space omni-directionally covered by transmission signals of antennae, specifically subspace 1, subspace 2, subspace 3 and subspace 4 in turn from left to right.

Wherein, the encoding may be Space Frequency Block Codes (SFBC); the initial data x₁, x₂, x₃ and x₄ may be processed with SFBC according to the encoding matrix, here, [x₁ 0 −x*₂0] may be sent on the sub-carrier 1, [x₂ 0 −x*₁0] may be sent on the sub-carrier 2, [0 x₃ 0 −x*₄] may be sent on the sub-carrier 3 and [0 x₄ 0 −x*₃] may be sent on the sub-carrier 4.

Wherein,

$$[ \begin{matrix}{x}_{1} \\ {x}_{2} \\ 0 \\ 0\end{matrix} ]$$

may be mapped to antenna group 1 corresponding to the subspace 1,

$$[ \begin{matrix}0 \\ 0 \\ {x}_{3} \\ {x}_{4}\end{matrix} ]$$

may be mapped to antenna group 2 corresponding to the subspace 2,

$$[ \begin{matrix}- {x}_{2}^{*} \\ {x}_{1}^{*} \\ 0 \\ 0\end{matrix} ]$$

may be mapped to antenna group 3 corresponding to the subspace 3, and

$$[ \begin{matrix}0 \\ 0 \\ - {x}_{4}^{*} \\ {x}_{3}^{*}\end{matrix} ]$$

may be mapped to antenna group 4 corresponding to the subspace 4.

Wherein, the step that the antenna group calculates a weight according to the channel information fed back by the terminal side and generates the directional grouping beam corresponding to the antenna groups may be that:

the antenna group 1 corresponding to the subspace 1 calculates a first weight [w₁₁ w₁₂] by which a directional grouping beam 1 corresponding to the antenna group 1 is generated, and the data sent by the directional grouping beam 1 is

$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$

the antenna group 2 corresponding to the subspace 2 calculates a second weight [w₂₁ w₂₂] by which a directional grouping beam 2 corresponding to the antenna group 2 is generated, and the data sent by the directional grouping beam 2 is

$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$

the antenna group 3 corresponding to the subspace 3 calculates a third weight [w₃₁ w₃₂] by which a directional grouping beam 3 corresponding to the antenna group 3 is generated, and the data sent by the directional grouping beam 3 is

$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$

and the antenna group 4 corresponding to the subspace 4 calculates a fourth weight [w₄₁ w₄₂] by which a directional grouping beam 4 corresponding to the antenna group 4 is generated, and the data sent by the directional grouping beam 4 is

$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$

The present invention sets an encoding matrix, in which frequencies corresponding to lines of the encoding matrix are neighboring sub-carries, and spaces corresponding to columns thereof are neighboring subspaces obtained by dividing an entire space; encodes input initial data according to the encoding matrix and sends encoded line data of the encoding matrix on the sub-carriers; maps encoded column data of the encoding matrix to antenna groups corresponding to the subspaces; and performs beam generation and generates grouping beams corresponding to antenna groups.

In the encoding matrix set by the present invention, the spaces corresponding to the columns are the neighboring subspaces obtained by dividing the entire space, different from the condition in the encoding matrix set by the prior art that the column corresponds to a specific antenna in the entire space omni-directionally covered by the transmission signals of antennae. It can be seen that, the present invention replaces a specific antenna in the entire space by a subspace in the setting of the encoding matrix, while the subspace can correspond to an antenna group which includes a plurality of antennae. Accordingly, the present invention is not limited by the specific number of antennae and is applicable the case of eight antennae or more antennae. Moreover, the division of subspaces may also be configured and expanded flexibly depending on actual need, different from the condition in the prior art that the entire space cannot be configured and expanded.

The encoding mode is various, such as, SFBC, which can be applied in combination with the generated grouping beams corresponding to the antenna groups to construct a solution for beamforming frequency encoding in the case of eight or more antennae in the multi-input multi-output system of the present invention; the solution for beamforming frequency encoding may also be called a transmission mode of beamforming frequency encoding. Further, the present invention performs beam generation for a plurality of antenna groups respectively to generate a plurality of directional grouping beams corresponding to the antenna groups, that is, to form a plurality of antenna groups into a plurality of directionally covering beams in sectors to replace the non-directional encoding corresponding to the omni-directional coverage of transmission signals of antennae in the prior art by the directional beams, thereby enabling the system to obtain obvious gain in the aspects of equivalent power, transmit diversity and the like.

To sum up, the adoption of the present invention better solves the transmission and data transfer in the case of eight antennae, even more antennae, capable of realizing the efficient and directional covering multi-antenna diversity in the case of multiple antennae, thereby improving diversity gain.

### BRIEF DESCRIPTION OF THE DRAWINGS

FIG. 1 shows a structural diagram of a device according to the present invention;

FIG. 2 shows a flowchart of implementing a method according to the present invention;

FIG. 3 shows a schematic diagram of the mapping from the virtual antenna ports to the actual antenna groups;

FIG. 4 shows a schematic diagram of generating the grouping beams corresponding to the multi-antenna groups.

### DETAILED DESCRIPTION

The basic idea of the present invention is: setting an encoding matrix, in which a certain antenna in the entire space is replaced by a subspace, and a subspace corresponds to an antenna group which includes a plurality of antennae. The encoding performed according to the encoding matrix is applied in combination with the grouping beams, generated by performing beam generation and correspond to antenna groups, to construct a solution for beamforming frequency encoding in the case of eight or more antennae in the multi-input multi-output system of the present invention, capable of obtaining obvious diversity gain.

The implementation of the technical solution will be illustrated with reference to the accompanying drawings hereinafter.

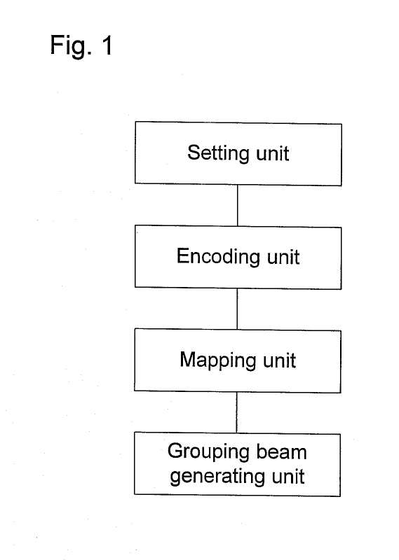

As shown in FIG. 1, a device for processing beamforming frequency comprises a setting unit, an encoding unit, a mapping unit and a grouping beam generating unit. The setting unit is used for setting an encoding matrix and sending the encoding matrix to the encoding unit. The encoding unit is used for encoding input initial data according to the encoding matrix. The mapping unit is used for obtaining encoded column data from the encoding unit and mapping the encoded column data to the antenna groups corresponding to subspaces. The grouping beam generating unit is used for performing beam generation and generating grouping beams corresponding to the antenna groups.

Here, the grouping beam generating unit is further used for calculating weights according to channel information fed back by a terminal side and generating directional grouping beams corresponding to the antenna groups.

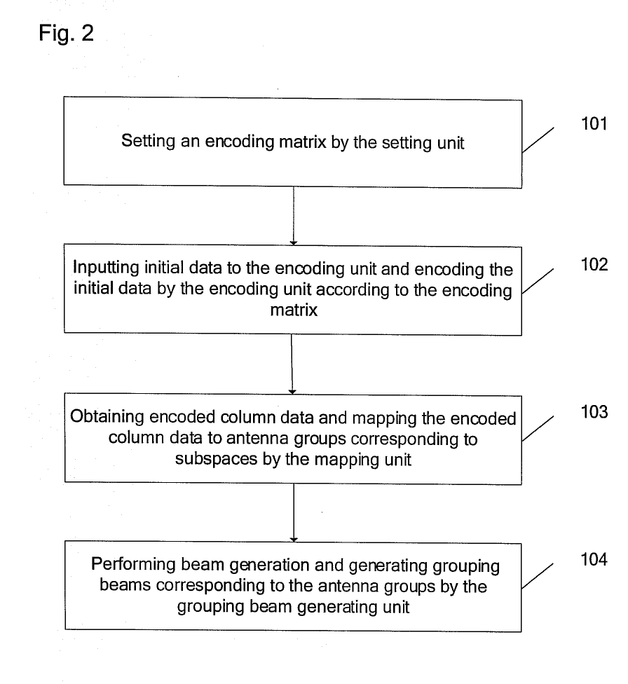

As shown in FIG. 2, a method for processing beamforming frequency comprises:

Step 101: setting an encoding matrix by the setting unit.

Here, frequencies corresponding to lines of the encoding matrix are neighboring sub-carriers, and spaces corresponding to columns of the encoding matrix are neighboring subspaces which are obtained by dividing an entire space. The entire space refers to an entire space omni-directionally covered by the transmission signals of antennae.

Step 102: inputting initial data to the encoding unit and encoding the initial data by the encoding unit according to the encoding matrix.

Step 103: obtaining encoded column data and mapping the encoded column data to antenna groups corresponding to subspaces by the mapping unit.

Here, the specific process of Step 103 is that: the mapping unit maps the encoded column data via a port to the antenna groups corresponding to the subspaces. The port mentioned in the present invention can be considered as a virtual antenna port which is different from an actual antenna port corresponding to an antenna in the prior art. The antenna group mentioned in the present invention can be considered as an actual antenna group including a plurality of antennae.

Besides, when mapping, the encoded column data are mapped via a port to a plurality of antenna groups each of which includes a plurality of antennae.

Step 104: performing beam generation and generating grouping beams corresponding to the antenna groups by the grouping beam generating unit.

Here, the specific process of Step 104 is that: at the grouping beam generating unit, an antenna group calculates a weight according to channel information fed back by a terminal side and generates an directional grouping beam corresponding to the antenna group.

A main lobe of a directional grouping beam directs the DOA at which the energy of the transmission signals of the antennae in the antenna group is the greatest.

For the technical solution above composed of Step 101 to Step 104, in Step 101, the set encoding matrix is:

$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$

in which x₁, x₂, x₃ and x₄ represent the initial data; the frequencies corresponding to different lines of the encoding matrix are different neighboring sub-carriers, specifically sub-carrier 1, sub-carrier 2, sub-carrier 3 and sub-carrier 4 in turn from top to down; the spaces corresponding to different columns of the encoding matrix are different neighboring subspaces obtained by dividing the entire space omni-directionally covered by the transmission signals of the antennae, specifically subspace 1, subspace 2, subspace 3 and subspace 4 in turn from left to right.

Specifically, the line data of the encoding matrix represents the data sent on the different neighboring sub-carries; specifically, from top to down, the first line represents the data sent on sub-carrier 1, the second line represents the data sent on sub-carrier 2, the third line represents the data sent on sub-carrier 3, and the fourth line represents the data sent on sub-carrier 4. The column data of the encoding matrix represents the data mapped to the antenna groups corresponding to different neighboring subspaces; specifically, from left to right, the first column represents the data mapped to the antenna group corresponding to subspace 1; the second column represents the data mapped to the antenna group corresponding to subspace 2; the third column represents the data mapped to the antenna group corresponding to subspace 3, and the fourth column represents the data mapped to the antenna group corresponding to subspace 4. Furthermore, in the condition that the encoding mode is SFBC, x₁, x₂, x₃ and x₄ are the symbols before space frequency block coding, x* represents the conjugation of x, for example, x*₁ represents the conjugation of x₁.

In Step 102, the encoding mode may specifically be SFBC. Initial data x₁, x₂, x₃ and x₄ are input to the encoding unit and the encoding unit performs SFBC according to the encoding matrix. Here, [x₁ 0 −x*₂ 0] is sent on sub-carrier 1, [x₂ 0 x*₁0] is sent on sub-carrier 2, [0 x₃ 0 −x*₄] is sent on sub-carrier 3, and [0 x₄ 0 −x*₃] is sent on sub-carrier 4.

It should be noted that, the encoding mode is various and is not limited to SFBC; the encoding mode may also be Space Time Block Codes (STBC). Here, for the set encoding matrix, each line of the encoding matrix corresponds to a different moment, the different spaces corresponding to different columns still are: the different neighboring subspaces obtained by dividing the entire space omni-directionally covered by the transmission signals of the antennae.

In Step 103, the mapping unit maps

$$[ \begin{matrix}{x}_{1} \\ {x}_{2} \\ 0 \\ 0\end{matrix} ]$$

to antenna group 1 corresponding to subspace 1, maps

$$[ \begin{matrix}0 \\ 0 \\ {x}_{3} \\ {x}_{4}\end{matrix} ]$$

to antenna group 2 corresponding to subspace 2, maps

$$[ \begin{matrix}- {x}_{2}^{*} \\ {x}_{1}^{*} \\ 0 \\ 0\end{matrix} ]$$

to antenna group 3 corresponding to subspace 3, and maps

$$[ \begin{matrix}0 \\ 0 \\ - {x}_{4}^{*} \\ {x}_{3}^{*}\end{matrix} ]$$

to antenna group 4 corresponding to subspace 4.

Further, in the specific process of Step 104, at the grouping beam generating unit, the antenna group 1 corresponding to the subspace 1 calculates, according to the channel information fed back by the terminal side, a first weight [w₁₁ wₙ] by which a directional grouping beam 1 corresponding to the antenna group 1 is generated, and the data sent by the directional grouping beam 1 is

$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] .$$

At the grouping beam generating unit, the antenna group 2 corresponding to the subspace 2 calculates, according to the channel information fed back by the terminal side, a second weight [w₂₁ w₂₂] by which a directional grouping beam 2 corresponding to the antenna group 2 is generated, and the data sent by the directional grouping beam 2 is

$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] .$$

At the grouping beam generating unit, the antenna group 3 corresponding to the subspace 3 calculates, according to the channel information fed back by the terminal side, a third weight [w₃₁ w₃₂] by which a directional grouping beam 3 corresponding to the antenna group 3 is generated, and the data sent by the directional grouping beam 3 is

$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] .$$

At the grouping beam generating unit, the antenna group 4 corresponding to the subspace 4 calculates, according to the channel information fed back by the terminal side, a fourth weight [w₄₁ w₄₂] by which a directional grouping beam 4 corresponding to the antenna group 4 is generated, and the data sent by the directional grouping beam 4 is

$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$

The method embodiment described hereinafter is the beamforming frequency processing method applied in LTE-A system in the case of eight antennae, which may also be called as a transmission method of LTE-A system in the case of eight antennae. By adopting the method in the LTE-A system, the eight-antenna downlink SFBC is combined with grouping beam generation, that is, the data encoded by the SFBC are mapped via different virtual antenna ports to the actual antenna groups and then a plurality of different antenna groups performs grouping beam generation respectively. Therefore, in the LTE-A system, by adopting the technical solution that the beamforming frequency encoding or SFBC is combined with eight-antenna grouping beam generation, compared with existing diversity technology of the simple four-antenna SFBC, the eight-antenna beamforming frequency encoding not only has diversity gain but also has power gain and expands coverage in the condition that the transmission power of each antenna is the same. Therefore, by adopting the method embodiment, the technical solution that SFBC is combined with eight-antenna grouping beam generation will bring many benefits to the system. The method embodiment is described hereinafter in detail.

The method embodiment is: a beamforming frequency processing method applied in the LTE-A system in the case of eight antennae. In the method embodiment, the implementation flow of the beamforming frequency processing method comprises the following steps of:

Step 201: setting an encoding matrix as

$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$

in which x₁, x₂, x₃ and x₄ are symbols before encoding, the lines of the encoding matrix represent neighboring sub-carriers, specifically sub-carrier 1, sub-carrier 2, sub-carrier 3 and sub-carrier 4 in turn from top to down, and the columns thereof represent neighboring subspaces, specifically subspace 1, subspace 2, subspace 3 and subspace 4 in turn from left to right. Subspace 1, subspace 2, subspace 3 and subspace 4 correspond to the grouping beams generated by the antenna groups corresponding to the respective subspace, respectively. For example, subspace 1 corresponds to the grouping beam 1 generated by the antenna group 1 corresponding to the subspace 1.

Step 202: encoding according to the encoding matrix, specifically performing SFBC according to encoding matrix. Here, [x₁ 0 −x*₂ 0] is sent on the sub-carrier 1, [x₂ 0 x*₁ 0] is sent on the sub-carrier 2, [0 x₃ 0 −x*₄] is sent on the sub-carrier 3, and [0 x₄ 0 −x*₃] is sent on the sub-carrier 4.

Step 203: mapping from a port to an antenna group, that is, mapping the data encoded by SFBC via a virtual antenna port to the corresponding actual antenna group.

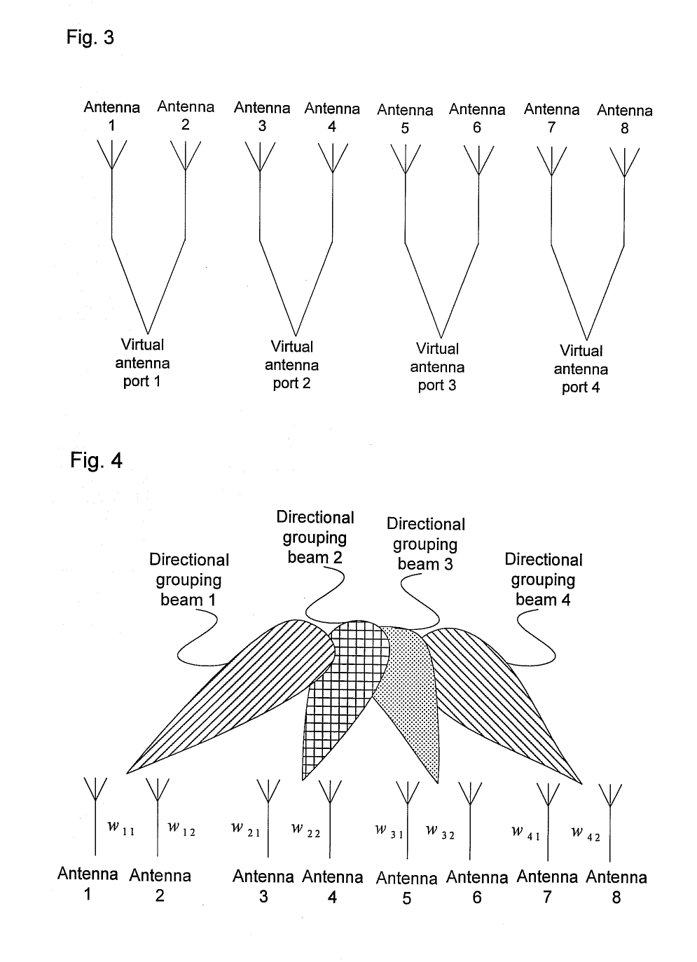

Here, as shown in FIG. 3, it is a schematic diagram of the mapping from the virtual antenna ports to the actual antenna groups. When mapping, the data encoded by SFBC is mapped via a virtual antenna port to at least one actual antenna group in which at least one antenna is included. For example, in the condition of eight antennae of the method embodiment, the eight antennae may be divided into four antenna groups each including two antennae. Specifically, a virtual antenna port 1 can be mapped to the antenna group 1 composed of antenna 1 and antenna 2, a virtual antenna port 2 can be mapped to the antenna group 2 composed of antenna 3 and antenna 4, a virtual antenna port 3 can be mapped to the antenna group 3 composed of antenna 5 and antenna 6, and a virtual antenna port 4 can be mapped to the antenna group 4 composed of antenna 7 and antenna 8.

Step 204: generating grouping beam, that is, performing beam generation for each antenna group.

Here, for example, the eight antennae on base station side are divided into four antenna groups each including two antennae. Each antenna group calculates, according to the channel information fed back by the terminal side, a weight by which a directional grouping beam corresponding to each antenna group is generated. The main lobe of the directional grouping beam directs the DOA at which the energy of the transmission signals of the antennae in the antenna group is the greatest, as shown in the schematic diagram of generating the grouping beams corresponding to the multi-antenna groups in FIG. 4.

As shown in FIG. 4, beam generation is performed for a plurality of antenna groups. The directional grouping beam 1 is formed by the calculated weight [w₁₁ w₁₂], and the direction points at the terminal. The weight [w₁₁ w₁₂] is calculated according to the channel information fed back by the terminal side, and the weight is calculated according to the prior art, that is, the weight is calculated according to the DOA (Direction of Arrival) of signals. The main lobe of directional grouping beam 1 directs the DOA at which the energy of the transmission signals of the antennae in the antenna group 1 is the greatest, wherein the antenna group 1 is composed of antenna 1 and antenna 2.

Here, for the directional grouping beam 1 formed by the weight [w₁₁ w₁₂] the data sent by the directional grouping beam 1 is

$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$

that is, for the sub-carrier 1, the antenna 1 in antenna group 1 transmits x₁w₁₁, and the antenna 2 transmits x₁w₁₂; for the sub-carrier 2, the antenna 1 in antenna group 1 transmits x₂w₁₁, and the antenna 2 transmits x₂w₁₂.

The directional grouping beam 2 is formed by the calculated weight [w₂₁ w₂₂] and the direction points at the terminal. The weight [w₂₁ w₂₂] is calculated according to the channel information fed back by terminal side, and the weight is calculated according to the prior art, that is, the weight is calculated according to the DOA of signals. The main lobe of directional grouping beam 2 directs the DOA at which the energy of the transmission signals of the antennae in the antenna group 2 is the greatest, wherein the antenna group 2 is composed of antenna 3 and antenna 4.

Here, for the directional grouping beam 2 formed by the weight [w₂₁ w₂₂], the data sent by the directional grouping beam 2 is

$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$

that is, for the sub-carrier 3, the antenna 3 in antenna group 2 transmits x₃w₂₁, and the antenna 4 transmits x₃w₂₂; for the sub-carrier 4, the antenna 3 in antenna group 2 transmits x₄w₂₁, and the antenna 4 transmits x₄w₂₂.

The directional grouping beam 3 is formed by the calculated weight [w₃₁ w₃₂], and the direction points at terminal. The weight [w₃₁ w₃₂] is calculated according to the channel information fed back by terminal side, and the weight is calculated according to the prior art, that is, the weight is calculated according to the DOA of signals. The main lobe of directional grouping beam 3 directs the DOA at which the energy of the transmission signals of the antennae in the antenna group 3 is the greatest, wherein the antenna group 3 is composed of antenna 5 and antenna 6.

Here, for the directional grouping beam 3 formed by the weight [w₃₁ w₃₂], the data sent by the directional grouping beam 3 is

$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$

that is, for the sub-carrier 1, the antenna 5 in antenna group 3 transmits −x*₂w₃₁, and the antenna 6 transmits −x*₂w₃₂; for the sub-carrier 2, the antenna 5 in antenna group 3 transmits x*₁w₃₁, and the antenna 6 transmits x*₁w₃.

The directional grouping beam 4 is formed by the calculated weight [w₄₁ w₄₂] and the direction points at terminal. The weight [w₄₁ w₄₂] is calculated according to the channel information fed back by terminal side, and the weight is calculated according to the prior art, that is, the weight is calculated according to the DOA of signals. The main lobe of directional grouping beam 4 directs the DOA at which the energy of the transmission signals of the antennae in the antenna group 4 is the greatest, wherein the antenna group 4 is composed of antenna 7 and antenna 8.

Here, for the directional grouping beam 4 formed by the weight[w₄₁ w₄₂], the data sent by the directional grouping beam 4 is

$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{42}\end{matrix} ] ;$$

that is, for the sub-carrier 3, the antenna 7 in antenna group 4 transmits −x*₄ w₄₁, and the antenna 8 transmits −x*₄ w₄₂; for the sub-carrier 4, the antenna 7 in antenna group 4 transmits x*₃w₄₁, and the antenna 8 transmits x*₃w₄₂.

To sum up, through the method embodiment, a beamforming frequency processing method applied in the LTE-A system in the case of eight antennae is provided; the beamforming frequency processing method may also be called as a beamforming frequency encoding transmission method. In the LTE-A system, the eight-antenna downlink SFBC is combined with the grouping beam generation to correspond different symbols to different subspace beams, which solves the problem in the prior art that no space frequency processing method is provided in the case of eight antennae, that is, solves the problem that the multi-antenna diversity in the case of eight antennae cannot be achieved in the prior art. By adopting the method embodiment, when different sub-carriers send signals, the omni-directional covering beam in the prior art is replaced by the directional covering beam which not only has a greater coverage but also has a directionality. Compared with the diversity technology of the simple four-antenna SFBC, the eight-antenna beamforming frequency encoding will bring, when the transmission power of each antenna is the same, 3 db of equivalent power gain, which is particularly important in the condition that the channel power is limited. Furthermore, the method can obtain better diversity gain and better coverage in the condition that extra pilot frequency overhead is not increased.

The above is only the preferred embodiment of the present invention and not intended to limit the protection scope of the present invention.

1. A device for processing beamforming frequency, comprising a setting unit, an encoding unit, a mapping unit and a grouping beam generating unit, wherein
the setting unit is used for setting an encoding matrix and sending the encoding matrix to the encoding unit;
the encoding unit is used for encoding input initial data according to the encoding matrix;
the mapping unit is used for obtaining encoded column data from the encoding unit and mapping the encoded column data to antenna groups corresponding to subspaces; and
the grouping beam generating unit is used for generating grouping beams corresponding to the antenna groups.

2. The device according to claim 1, wherein the grouping beam generating unit is further used for calculating weights according to channel information fed back by a terminal side and generating directional grouping beams corresponding to the antenna groups.

3. A method for processing beamforming frequency, comprising:
setting an encoding matrix, wherein frequencies corresponding to lines of the encoding matrix are neighboring sub-carriers, and spaces corresponding to columns thereof are neighboring subspaces which are obtained by dividing an entire space;
encoding initial data according to the encoding matrix;
obtaining encoded column data and mapping the encoded column data to antenna groups corresponding to the subspaces; and
generating grouping beams corresponding to the antenna groups.

4. The method according to claim 3, wherein the encoded column data are further mapped to the antenna groups corresponding to the subspaces via a port;
when mapping, the encoded column data are mapped via a port to at least one antenna group in which at least one antenna is included.

5. The method according to claim 3, wherein the step of generating the grouping beams corresponding to the antenna groups further comprises: calculating by an antenna group a weight according to channel information fed back by a terminal side and generating a directional grouping beam corresponding to the antenna group.

6. The method according to claim 5, wherein a main lobe of the directional grouping beam directs a Direction of Arrival (DOA) at which energy of transmission signals of the antennae in the antenna group is the greatest.

7. The method according to claim 3, wherein the encoding matrix is
$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$
in which x₁, x₂, x₃ and x₄ represent the initial data; frequencies corresponding to different lines of the encoding matrix are different neighboring sub-carriers, specifically sub-carrier 1, sub-carrier 2, sub-carrier 3 and sub-carrier 4 in turn from top to down; spaces corresponding to different columns are different neighboring subspaces obtained by dividing an entire space omni-directionally covered by transmission signals of antennae, specifically subspace 1, subspace 2, subspace 3 and subspace 4 in turn from left to right.

8. The method according to claim 7, wherein the encoding is Space Frequency Block Codes (SFBC); the initial data x₁, x₂, x₃ and x₄ are processed with SFBC according to the encoding matrix, here, [x₁ 0 −x*₂ 0] is sent on the sub-carrier 1, [x₂ 0 x*₁ 0] is sent on the sub-carrier 2, [0 x₃ 0 −x*₄] is sent on the sub-carrier 3, and [0 x₄ 0 −x*₃] is sent on the sub-carrier 4.

9. The method according to claim 8, wherein
$$[ \begin{matrix}{x}_{1} \\ {x}_{2} \\ 0 \\ 0\end{matrix} ]$$
is mapped to antenna group 1 corresponding to the subspace 1,
$$[ \begin{matrix}0 \\ 0 \\ {x}_{3} \\ {x}_{4}\end{matrix} ]$$
is mapped to antenna group 2 corresponding to the subspace 2,
$$[ \begin{matrix}- {x}_{2}^{*} \\ {x}_{1}^{*} \\ 0 \\ 0\end{matrix} ]$$
is mapped to antenna group 3 corresponding to the subspace 3, and
$$[ \begin{matrix}0 \\ 0 \\ - {x}_{4}^{*} \\ {x}_{3}^{*}\end{matrix} ]$$
is mapped to antenna group 4 corresponding to the subspace 4.

10. The method according to claim 9, wherein the step that the antenna group calculates a weight according to the channel information fed back by the terminal side and generates the directional grouping beam corresponding to the antenna group is that:
the antenna group 1 corresponding to the subspace 1 calculates a first weight [w₁₁ w₁₂] by which a directional grouping beam 1 corresponding to the antenna group 1 is generated, and the data sent by the directional grouping beam 1 is
$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$
the antenna group 2 corresponding to the subspace 2 calculates a second weight [w₂₁ w₂] by which a directional grouping beam 2 corresponding to the antenna group 2 is generated, and the data sent by the directional grouping beam 2 is
$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$
the antenna group 3 corresponding to the subspace 3 calculates a third weight [w₃₁ w₃₂] by which a directional grouping beam 3 corresponding to the antenna group 3 is generated, and the data sent by the directional grouping beam 3 is
$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$
and
the antenna group 4 corresponding to the subspace 4 calculates a fourth weight [w₄₁ w₄₂] by which a directional grouping beam 4 corresponding to the antenna group 4 is generated, and the data sent by the directional grouping beam 4 is
$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$

11. The method according to claim 4, wherein the encoding matrix is
$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$
in which x₁, x₂, x₃ and x₄ represent the initial data; frequencies corresponding to different lines of the encoding matrix are different neighboring sub-carriers, specifically sub-carrier 1, sub-carrier 2, sub-carrier 3 and sub-carrier 4 in turn from top to down; spaces corresponding to different columns are different neighboring subspaces obtained by dividing an entire space omni-directionally covered by transmission signals of antennae, specifically subspace 1, subspace 2, subspace 3 and subspace 4 in turn from left to right.

12. The method according to claim 5, wherein the encoding matrix is
$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$
in which x₁, x₂, x₃ and x₄ represent the initial data; frequencies corresponding to different lines of the encoding matrix are different neighboring sub-carriers, specifically sub-carrier 1, sub-carrier 2, sub-carrier 3 and sub-carrier 4 in turn from top to down; spaces corresponding to different columns are different neighboring subspaces obtained by dividing an entire space omni-directionally covered by transmission signals of antennae, specifically subspace 1, subspace 2, subspace 3 and subspace 4 in turn from left to right.

13. The method according to claim 6, wherein the encoding matrix is
$$[ \begin{matrix}{x}_{1} & 0 & - {x}_{2}^{*} & 0 \\ {x}_{2} & 0 & {x}_{1}^{*} & 0 \\ 0 & {x}_{3} & 0 & - {x}_{4}^{*} \\ 0 & {x}_{4} & 0 & {x}_{3}^{*}\end{matrix} ] ,$$
in which x₁, x₂, x₃ and x₄ represent the initial data; frequencies corresponding to different lines of the encoding matrix are different neighboring sub-carriers, specifically sub-carrier 1, sub-carrier 2, sub-carrier 3 and sub-carrier 4 in turn from top to down; spaces corresponding to different columns are different neighboring subspaces obtained by dividing an entire space omni-directionally covered by transmission signals of antennae, specifically subspace 1, subspace 2, subspace 3 and subspace 4 in turn from left to right.

14. The method according to claim 11, wherein the encoding is Space Frequency Block Codes (SFBC); the initial data x₁, x₂, x₃ and x₄ are processed with SFBC according to the encoding matrix, here, [x₁ 0 −x*₂ 0] is sent on the sub-carrier 1, [x₂ 0 x*₁ 0] is sent on the sub-carrier 2, [0 x₃ 0 −x*₄] is sent on the sub-carrier 3, and [0 x₄ 0 −x*₃] is sent on the sub-carrier 4.

15. The method according to claim 12, wherein the encoding is Space Frequency Block Codes (SFBC); the initial data x₁, x₂, x₃ and x₄ are processed with SFBC according to the encoding matrix, here, [x₁ 0 −x*₂ 0] is sent on the sub-carrier 1, [x₂ 0 x*₂ 0] is sent on the sub-carrier 2, [0 x₃ 0 −x₄] is sent on the sub-carrier 3, and [0 x₄ 0 −x₄] is sent on the sub-carrier 4.

16. The method according to claim 13, wherein the encoding is Space Frequency Block Codes (SFBC); the initial data x₁, x₂, x₃ and x₄ are processed with SFBC according to the encoding matrix, here, [x₁ 0 −x*₂ 0] is sent on the sub-carrier 1, [x₂ 0 x*₁ 0] is sent on the sub-carrier 2, [0 x₃ 0 −x*₄] is sent on the sub-carrier 3, and [0 x₄ 0 −x*₃] is sent on the sub-carrier 4.

17. The method according to claim 14, wherein
$$[ \begin{matrix}{x}_{1} \\ {x}_{2} \\ 0 \\ 0\end{matrix} ]$$
is mapped to antenna group 1 corresponding to the subspace 1,
$$[ \begin{matrix}0 \\ 0 \\ {x}_{3} \\ {x}_{4}\end{matrix} ]$$
is mapped to antenna group 2 corresponding to the subspace 2,
$$[ \begin{matrix}- {x}_{2}^{*} \\ {x}_{1}^{*} \\ 0 \\ 0\end{matrix} ]$$
is mapped to antenna group 3 corresponding to the subspace 3, and
$$[ \begin{matrix}0 \\ 0 \\ - {x}_{4}^{*} \\ {x}_{3}^{*}\end{matrix} ]$$
is mapped to antenna group 4 corresponding to the subspace 4.

18. The method according to claim 15, wherein
$$[ \begin{matrix}{x}_{1} \\ {x}_{2} \\ 0 \\ 0\end{matrix} ]$$
is mapped to antenna group 1 corresponding to the subspace 1,
$$[ \begin{matrix}0 \\ 0 \\ {x}_{3} \\ {x}_{4}\end{matrix} ]$$
is mapped to antenna group 2 corresponding to the subspace 2,
$$[ \begin{matrix}- {x}_{2}^{*} \\ {x}_{1}^{*} \\ 0 \\ 0\end{matrix} ]$$
is mapped to antenna group 3 corresponding to the subspace 3, and
$$[ \begin{matrix}0 \\ 0 \\ - {x}_{4}^{*} \\ {x}_{3}^{*}\end{matrix} ]$$
is mapped to antenna group 4 corresponding to the subspace 4.

19. The method according to claim 16, wherein
$$[ \begin{matrix}{x}_{1} \\ {x}_{2} \\ 0 \\ 0\end{matrix} ]$$
is mapped to antenna group 1 corresponding to the subspace 1,
$$[ \begin{matrix}0 \\ 0 \\ {x}_{3} \\ {x}_{4}\end{matrix} ]$$
is mapped to antenna group 2 corresponding to the subspace 2,
$$[ \begin{matrix}- {x}_{2}^{*} \\ {x}_{1}^{*} \\ 0 \\ 0\end{matrix} ]$$
is mapped to antenna group 3 corresponding to the subspace 3, and
$$[ \begin{matrix}0 \\ 0 \\ - {x}_{4}^{*} \\ {x}_{3}^{*}\end{matrix} ]$$
is mapped to antenna group 4 corresponding to the subspace 4.

20. The method according to claim 17, wherein the step that the antenna group calculates a weight according to the channel information fed back by the terminal side and generates the directional grouping beam corresponding to the antenna group is that:
the antenna group 1 corresponding to the subspace 1 calculates a first weight [w₁₁ w₁₂] by which a directional grouping beam 1 corresponding to the antenna group 1 is generated, and the data sent by the directional grouping beam 1 is
$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$
the antenna group 2 corresponding to the subspace 2 calculates a second weight [w₂₁ w₂₂] by which a directional grouping beam 2 corresponding to the antenna group 2 is generated, and the data sent by the directional grouping beam 2 is
$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$
the antenna group 3 corresponding to the subspace 3 calculates a third weight [w₃₁ w₃₂] by which a directional grouping beam 3 corresponding to the antenna group 3 is generated, and the data sent by the directional grouping beam 3 is
$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$
and
the antenna group 4 corresponding to the subspace 4 calculates a fourth weight [w₄₁ w₄₂] by which a directional grouping beam 4 corresponding to the antenna group 4 is generated, and the data sent by the directional grouping beam 4 is
$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$

21. The method according to claim 18, wherein the step that the antenna group calculates a weight according to the channel information fed back by the terminal side and generates the directional grouping beam corresponding to the antenna group is that:
the antenna group 1 corresponding to the subspace 1 calculates a first weight [w₁₁ w₁₂] by which a directional grouping beam 1 corresponding to the antenna group 1 is generated, and the data sent by the directional grouping beam 1 is
$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$
the antenna group 2 corresponding to the subspace 2 calculates a second weight [w₂₁ w₂₂] by which a directional grouping beam 2 corresponding to the antenna group 2 is generated, and the data sent by the directional grouping beam 2 is
$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$
the antenna group 3 corresponding to the subspace 3 calculates a third weight [w₃₁ w₃₂] by which a directional grouping beam 3 corresponding to the antenna group 3 is generated, and the data sent by the directional grouping beam 3 is
$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$
and
the antenna group 4 corresponding to the subspace 4 calculates a fourth weight [w₄₁ w₄₂] by which a directional grouping beam 4 corresponding to the antenna group 4 is generated, and the data sent by the directional grouping beam 4 is
$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$

22. The method according to claim 19, wherein the step that the antenna group calculates a weight according to the channel information fed back by the terminal side and generates the directional grouping beam corresponding to the antenna group is that:
the antenna group 1 corresponding to the subspace 1 calculates a first weight [w₁ₗ w₁₂] by which a directional grouping beam 1 corresponding to the antenna group 1 is generated, and the data sent by the directional grouping beam 1 is
$$[ \begin{matrix}{x}_{1} {w}_{11} + {x}_{1} {w}_{12} \\ {x}_{2} {w}_{11} + {x}_{2} {w}_{12} \\ 0 \\ 0\end{matrix} ] ;$$
the antenna group 2 corresponding to the subspace 2 calculates a second weight [w₂₁ w₂₂] by which a directional grouping beam 2 corresponding to the antenna group 2 is generated, and the data sent by the directional grouping beam 2 is
$$[ \begin{matrix}0 \\ 0 \\ {x}_{3} {w}_{21} + {x}_{3} {w}_{22} \\ {x}_{4} {w}_{21} + {x}_{4} {w}_{22}\end{matrix} ] ;$$
the antenna group 3 corresponding to the subspace 3 calculates a third weight [w₃₁ w₃₂] by which a directional grouping beam 3 corresponding to the antenna group 3 is generated, and the data sent by the directional grouping beam 3 is
$$[ \begin{matrix}- {x}_{2}^{*} {w}_{31} - {x}_{2}^{*} {w}_{31} \\ {x}_{1}^{*} {w}_{31} + {x}_{1}^{*} {w}_{31} \\ 0 \\ 0\end{matrix} ] ;$$
and
the antenna group 4 corresponding to the subspace 4 calculates a fourth weight [w₄₁ w₄₂] by which a directional grouping beam 4 corresponding to the antenna group 4 is generated, and the data sent by the directional grouping beam 4 is
$$[ \begin{matrix}0 \\ 0 \\ - {x}_{4}^{*} {w}_{41} - {x}_{4}^{*} {w}_{42} \\ {x}_{3}^{*} {w}_{41} + {x}_{3}^{*} {w}_{41}\end{matrix} ] .$$
